(19) United States
(12) Patent Application Publication
(10) Pub. No.: US 2010/0332350 A1
(43) Pub. Date: Dec. 30, 2010

(54) SYSTEMS AND METHODS FOR BUILDING A PRODUCT

(75) Inventors: Tristan G. RINEHART, San Francisco, CA (US); James LOWRY, Sunnyvale, CA (US); Kirill ULYANOV, San Francisco, CA (US); Malcolm HANSEN, San Francisco, CA (US); Howard A. BURROWS, Oakland, CA (US); Karen SWANSON, San Jose, CA (US); Keith Lowell DOHERTY, San Francisco, CA (US)

Correspondence Address: Reed Smith LLP, P.O. Box 488, Pittsburgh, PA, 15230, US

(73) Assignee: CBS INTERACTIVE,INC., County of New Castle, DE (US)

(21) Appl. No.: 12/491,078

(22) Filed: Jun. 24, 2009

(51) Int. Cl. G06Q 30/00; G06F 17/50; G06N 5/02

(52) U.S. Cl. 705/27; 700/107; 706/47

(57) ABSTRACT

Systems and methods for building a product that has a plurality of components. A product builder receives the user request to build the product and communicates with one or more APIs that identify a category of the product, a plurality of components associated with the category of the product, and relationships between the plurality of components. The product builder then displays a first list of components in the category of the product. The product builder receives a user selection of one of components in the first list, and then displays a second list of components that are compatible with the first selected component. The user then selects one of the components in the second list, and so on, until the product is ready to be built. The product builder can then be used to purchase the built product that is specific to the user or direct the user to websites that sell each of the components necessary to build the product.

### BACKGROUND

1. Field

The subject invention relates to systems and methods for building a product online and, in particular, to systems and methods for building a computer online.

2. Related Art

Most retail brand computers are sold as pre-packaged computers that are combinations of various computer components. For example, Dell, Sony, IBM and Apple and all sell pre-packed computers. Websites exist that can help users identify the best retail or pre-packaged computer for them. For example, cnet.com offers users a Desktop buying guide that identifies recommended desktops for certain types of users (e.g., general purpose user, power user, home theater enthusiast, home office worker). However, when users identify one of these computers to purchase, the user, typically, cannot change the components of the retail brand or pre-packaged computer.

Some tech-savvy consumers prefer to build their own computers. These tech-savvy consumers spend a significant amount of time researching various computer components and, based on their research, identify the components that best suit their needs. These consumers then purchase the components separately, and assemble the components to build a customized computer themselves. There are, however, no online tools that help these tech-savvy consumers build their customized computer.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a computer system is provided that includes a first application programming interface configured to access component specifications; a second application programming interface configured to access a relationship engine that identifies relationships between components; and an application coupled to the first application programming interface and the second application programming interface, and configured to receive a user input from a user to build a product and identify components that can be used to build the product using the relationships between the components and the component specifications.

The application may be a widget embeddable on a web page.

The application may include a plurality of rules for identifying components based on the specifications and relationships, and an engine executes the rules in response to user input and displays the identified components to the user.

The first application programming interface may further be configured to access component pricing data and component images, and the application may be configured to display the component pricing data and component images.

The application may be configured to receive user input identifying a plurality of components to build the product.

The application may be configured to display the product with a link to purchase each of the plurality of components.

The application may be configured to display the product with a link to order a built product that includes the plurality of components.

The product may be a computer.

According to another aspect of the invention, a computer-implemented method is provided that includes receiving a user request to build a product having a plurality of components; identifying a category of the product, a plurality of components associated with the category of the product, and relationships between the plurality of components; displaying a first list of a plurality of components associated with the category of the product; receiving a user selection of one of the plurality of components in the first list; displaying a second list of a plurality of components that are compatible with the user selected component using the identified relationships; receiving a user selection of one of the plurality of components in the second list; and displaying the user-selected components.

Identifying the relationships between the plurality of components may include identifying specifications for the plurality of components and analyzing the specifications of the plurality of components to determine compatibility.

Displaying the second list of the plurality of components may include identifying a plurality of components associated with a category of the selected component.

The method may also include identifying specifications for each of the plurality of components, and identifying the relationships between the plurality of components may include analyzing the specifications of the plurality of components to determine compatibility.

The method may also include accessing component pricing data and component images, and wherein displaying the first list and the second list and may include displaying the pricing data and the images.

The method may also include determining the compatibility of the plurality of components in the first list with the category of the product before displaying the first list of plurality of components; and determining the compatibility of the plurality of components in the second list with the user selected component from the first list.

According to a further aspect of the invention, a computer-readable storage media having computer executable instructions stored thereon which cause a computer system to carry out the method described above when executed.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram of a system for building a product according to one embodiment of the invention.

FIG. 2 is a block diagram of an architecture for building a product according to one embodiment of the invention.

FIG. 3 is a detailed block diagram of an architecture for building a product according to one embodiment of the invention.

FIG. 4 is a flow diagram of a method of building a product according to one embodiment of the invention.

FIG. 5 is a detailed flow diagram of a method of building a product according to one embodiment of the invention.

FIG. 5A is a detailed view of an exemplary category sequence according to one embodiment of the invention.

FIG. 5B is a detailed view of an exemplary parent-child mapping according to one embodiment of the invention.

FIGS. 6A-6G are schematic views of user interfaces for building a product according to one embodiment of the invention.

FIG. 7 is a schematic diagram of an exemplary computer system according to one embodiment of the invention.

### DETAILED DESCRIPTION

Systems and methods for building a product (i.e., a product builder) that has a plurality of components are described. In one embodiment, the product builder is a web widget that allows users to build a desktop. The product builder is a browser-based product selection wizard, and allows users to select computer system components to add to a shopping list of compatible parts so the user can then build their own product, such as a desktop computer. The product builder ensures the components are compatible which helps recreate the online customization experience of retail computer system brands.

For example, the widget may receive a user request to build a product and communicates with one or more APIs that identify a category of the product, a plurality of components associated with the category of the product, and relationships between the plurality of components. The widget then displays a first list of components in the category of the product. The widget receives a user selection of one of components in the first list, and then displays a second list of components that are compatible with the first selected component. The user then selects one of the components in the second list, and so on, until the product is ready to be built. The widget can then be used to purchase the built product that is specific to the user or direct the user to websites that sell each of the components necessary to build the product.

These systems and methods are advantageous because building a product, such as desktop, no longer requires independent research to determine component compatibility. The widget or application can be configured to automatically display, for example, compatible components, pricing lead-outs, reviews, popularity information and the like.

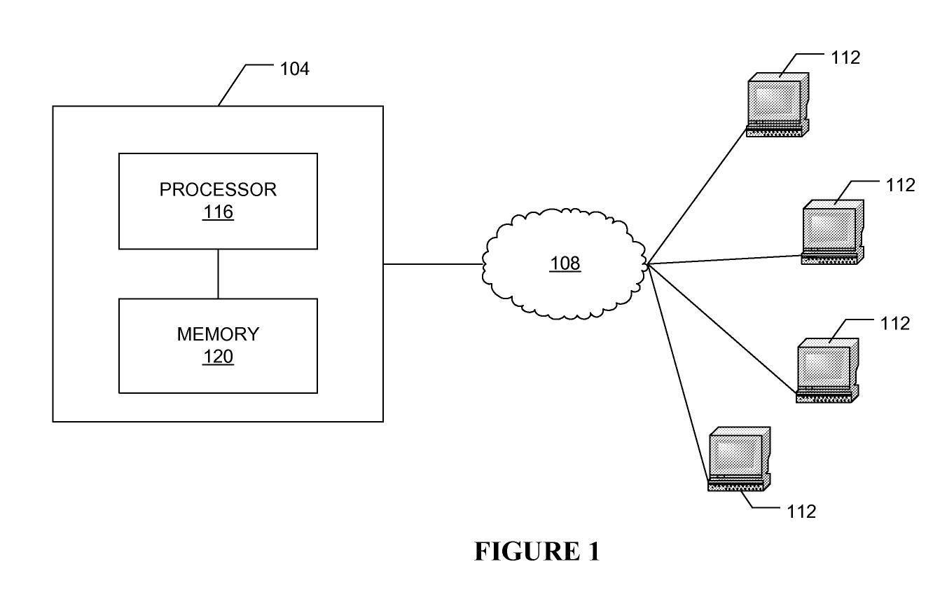

An embodiment of the invention will now be described in detail with reference to FIG. 1. FIG. 1 illustrates a server 104 that is connected over a network 108 to a plurality of user systems 112. The server 104 includes a processor 116 and memory 120, which are in communication with one another.

The server 104 is configured to deliver online content to users at the user systems 112. The server 104 is typically a computer system, and may be an HTTP (Hypertext Transfer Protocol) server such as an Apache server. The memory 120 may be any type of storage media that may be volatile or non-volatile memory that includes, for example, read only memory (ROM), random access memory (RAM), magnetic disk storage media, optical storage media, flash memory devices and zip drives.

The network 108 is a local area network (LAN), wide area network (WAN), a telephone network, such as the Public Switched Telephone Network (PSTN), an intranet, the Internet, or combinations thereof.

The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers.

In use, when a user of one of the plurality of user systems 112 is browsing a web page, a request to access content is communicated to the server 104 over the network 108. For example, a signal is transmitted from one of the user systems 112, the signal having a destination address (e.g., address representing the server), a request (e.g., content request) and a return address (e.g., address representing user system that initiated the request). The processor 116 accesses the memory 120 to provide the requested content, which is communicated to the user over the network 108. For example, another signal may be transmitted that includes a destination address corresponding to the return address of the client system, and the content responsive to the request.

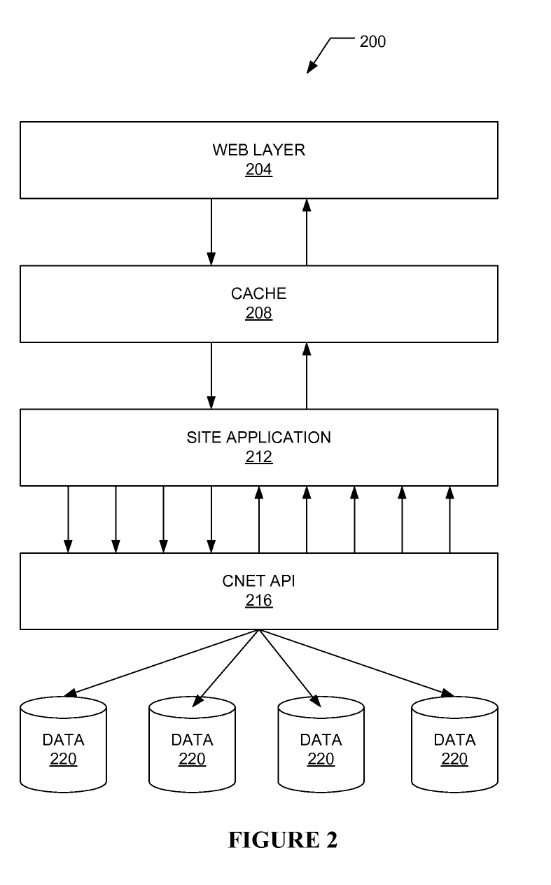

FIG. 2 illustrates an exemplary system architecture 200 at the server 104 according to one embodiment of the invention. It will be appreciated that the system architecture may be implemented as one server (e.g., server 104) or a plurality of servers in communication with one another

As shown in FIG. 2, the system architecture 200 includes a web layer 204, a cache 208, a site application 212, a CNET API (application programming interface) 216 and a plurality of data stores 220. It will be appreciated that the system architecture may vary from the illustrated architecture. For example, the web layer 204 may directly access the data stores 220, the site application may directly access the data stores 220, the system architecture 200 may not include the cache 208, etc., as will be appreciated by those skilled in the art.

The web layer 204 is configured to receive user requests to access content through a web browser and return content that is responsive to the user request. The web layer 204 communicates the user requests to the cache 208.

The cache 208 is configured to temporarily store content that is accessed frequently by the web layer 204 and can be rapidly accessed by the web layer 204. In one embodiment, the cache 208 may be a caching proxy server. The cache 208 communicates the user requests to the site application 212.

The site application 212 is configured to update the cache 208 and to process user requests received from the web layer 204. The site application 212 may identify that the user request is for a page that includes data from multiple sources. The site application 212 can then convert the page request into a request for content from multiple sources and transmits these requests to the CNET API.

The CNET API 216 is configured to simultaneously access data from the plurality of data stores 220 to collect the data responsive to the plurality of requests from the site application 212. The plurality of data stores 220 include catalogue data about different product types (e.g., product specifications, pricing, images, etc.). It will be appreciated that in alternative embodiments only one data store 220 may be provided to store the data.

The data in the data stores 220 is provided to the CNET API 216, which provides the content to the site application 212. The site application 212 updates the cache 208 and delivers the cached content in combination with the accessed content to the web layer 204, which delivers browsable content to the user.

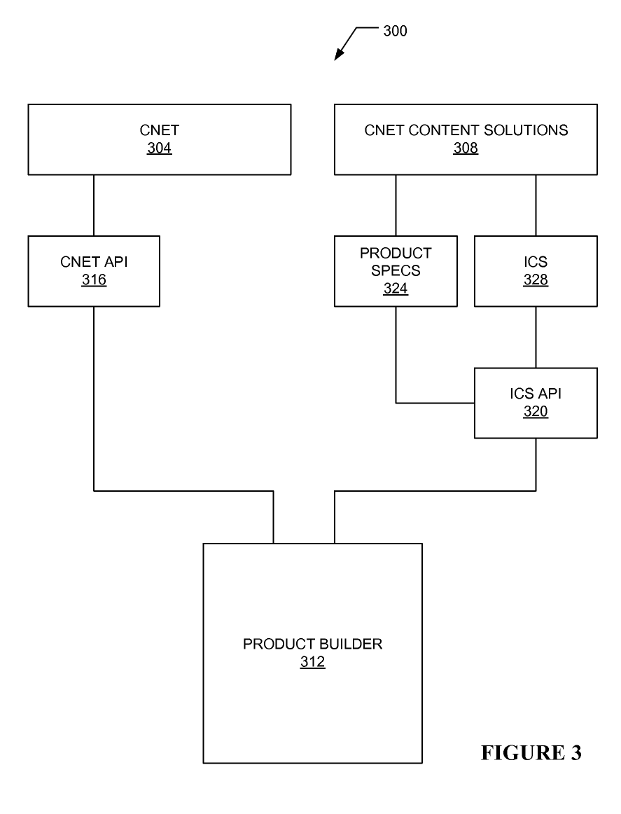

FIG. 3 illustrates a detailed system for building a product 300 according to one embodiment of the invention. As shown in FIG. 3, the system 300 includes a CNET application 304 and CNET Content Solutions application 308 that are in communication with a product builder 312. A CNET API 316 is provided between the CNET layer 304 and the product builder 312. An Intelligent Cross Sell (ICS) API 320 is also provided that is in communication with product specifications 324 and ICS 328 which are in communication with the CNET Content Solutions Layer 308.

Product catalog information and component relation data is downloaded from the CNET API 316 and the CNET Content Solutions ICS API 320, respectively, to the product builder 312. The product builder 312 allows users to select computer system components to add to a shopping list of compatible parts so the user can then build their own product, such as a desktop computer. The product builder 312 ensures the components are compatible. In particular, the product builder 312 analyzes the catalog information and component relation data from the CNET API 316 and the ICS API 320. In one embodiment, the product builder 312 includes a rules data store and a rules engine (not shown). The rules data store may include rules that can be used to determine the compatibility of products. The rules engine accesses the rules in the rules data store and determines whether product data provided by the CNET API 316 and the ICS API 320 are compatible. For example, the product builder 312 may compare attributes of the products. In particular, if the product is a desktop and a component is a hard-drive, the processing speed of the graphics card may need to be evaluated with respect to the processing speed of the hard drive. If the proceeding speed of the graphics card is compatible with the processing speed of the hard drive, that graphics card is displayed to the user.

The product builder 312 may be a browser-based product selection wizard. In one embodiment, the product builder 312 is an embeddable widget.

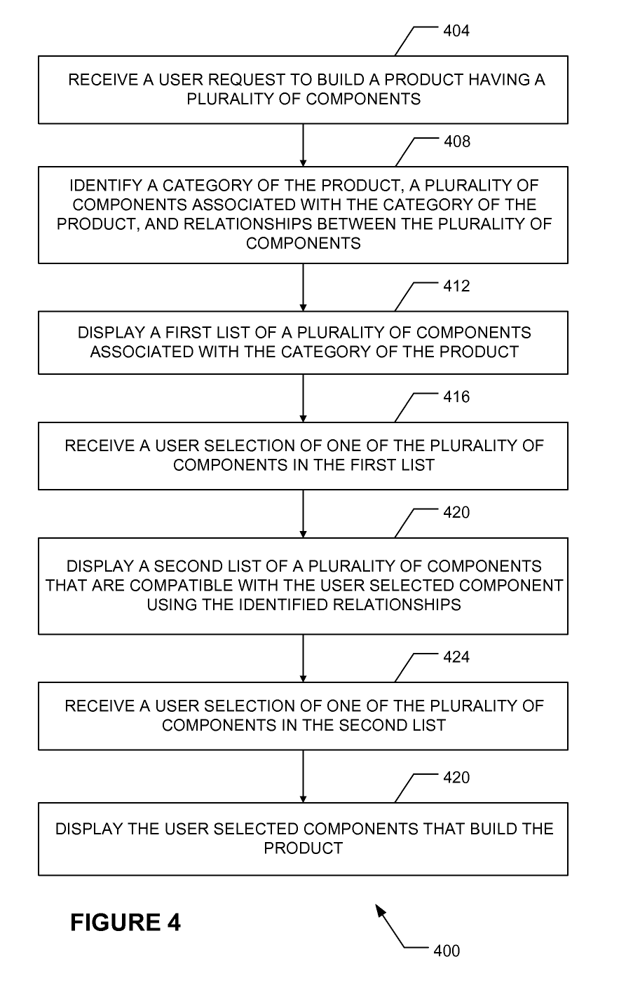

FIG. 4 illustrates a process 400 for building a product in accordance with one embodiment of the invention. It will be appreciated that the process 400 described below is merely exemplary and may include a fewer or greater number of steps, and that the order of at least some of the steps may vary from that described below.

The process 400 begins by receiving a user request to build a product having a plurality of components (block 404). For example, a user may navigate to a web page that has a desktop computer builder widget embedded thereon and select a link indicating their desire to build a desktop computer (e.g., a performance desktop computer).

The process 400 continues by identifying a category of the product, a plurality of components associated with the category of the product, and relationships between the plurality of components (block 408). For example, the desktop builder may determine that the category is a performance desktop and then identifies components that are associated with the performance desktop category.

The process 400 continues by displaying a first list of a plurality of components associated with the category of the product (block 412). For example, the desktop builder may display all the graphic cards that are associated with the performance desktop category that was selected by the user. It will be appreciated that the product builder may display the list of the plurality of components so that they are ranked. In such an embodiment, the product builder 312 may include a ranking algorithm to rank the compatible products as known to those skilled in the art.

The process 400 continues by receiving a user selection of one of the plurality of components in the first list (block 416). For example, the user selects a link on the web page that is associated with one of the components displayed to the user and the selection is communicated to the desktop builder application by the web browser.

The process 400 continues by displaying a second list of a plurality of components that are compatible with the user selected component using the identified relationships (block 420). For example, the desktop builder may identify the selected component and determine identify components in a next category for that product and determine whether those components are compatible with the selected component. The determination includes analyzing the specification and relationship data from, for example, the ICS API, and the catalog information from, for example, the CNET API. It will be appreciated that the product builder may display the list of the plurality of components so that they are ranked. In such an embodiment, the product builder 312 may include a ranking algorithm to rank the compatible products as known to those skilled in the art.

The process 400 continues by receiving a user selection of one of the plurality of components in the second list (block 424). For example, the user selects a link on the web page that is associated with one of the components displayed to the user and the selection is communicated to the desktop builder application by the web browser.

The process 400 continues by displaying the user selected components that build the product (block 428). For example, the product builder compiles a list of each of the components selected by the user, and then transmits the compilation list to the browser. It will be appreciated that the compilation list may include pricing information for the components and/or the product, links to websites that sell each of the selected components, a link to purchase each of the selected components, etc.

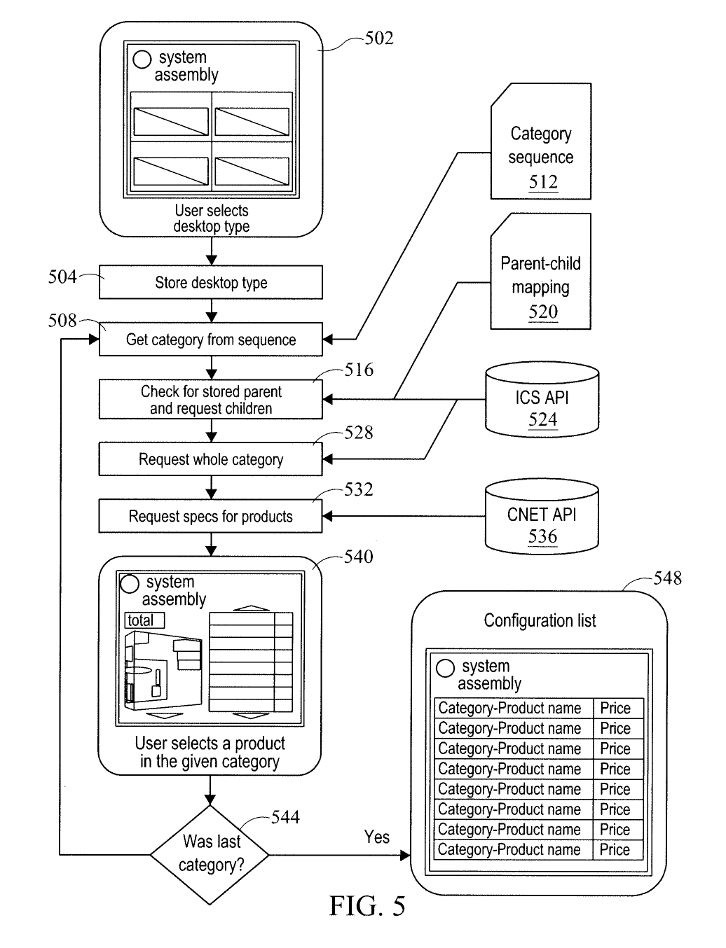

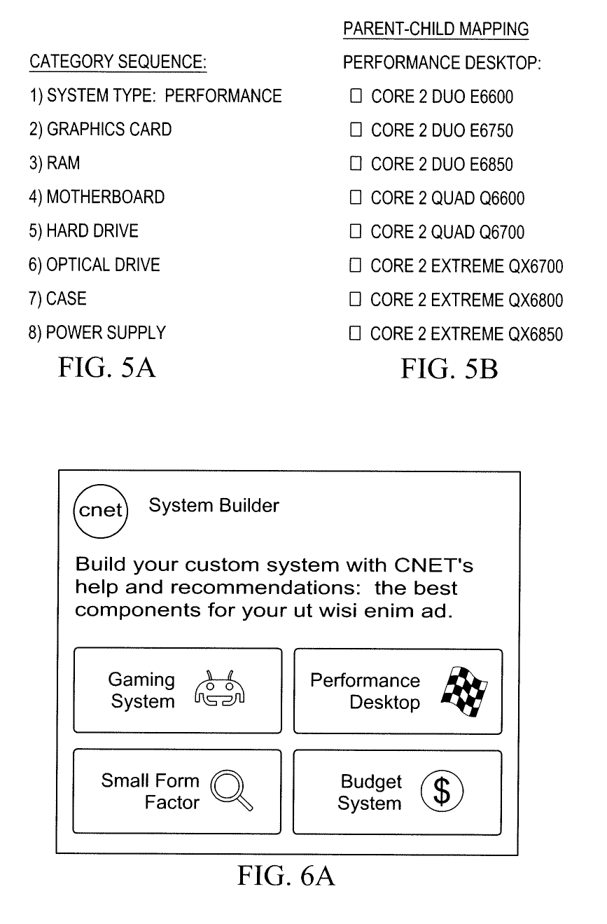

FIG. 5 illustrates a process 500 for building a product in accordance with one embodiment of the invention. It will be appreciated that the process 500 described below is merely exemplary and may include a fewer or greater number of steps, and that the order of at least some of the steps may vary from that described below.

The process 500 begins by the user selecting a desktop type (block 502), and storing the desktop type (block 504).

The process 500 continues by getting a category from sequence (block 508) from the category sequence index 512. For example, as shown in FIG. 5A, an exemplary category sequence index for a desktop computer may be: 1) desktop type=performance desktop; 2) graphics card; 3) RAM; 4) motherboard; 5) hard drive; 6) optical drive; 7) case; and, 8) power supply. In the illustrated example, after the user selects performance desktop, the next category from the sequence is, therefore, the graphics card.

The process 500 continues by checking for stored parent and request children (block 516) using the parent-child mapping application 520 and the ICS API 524. For example, the graphics cards for performance desktops are checked by examining the parent-child mapping and/or the ICS API. FIG. 5B illustrates an exemplary parent-child mapping according to one embodiment of the invention. The parent-child mapping describes the relationship that exists between the product categories and the main product. For example, as shown in FIG. 5C, the processors that are recommended for performance desktops may include: Core 2 Duo E6600, Core 2 Duo E6750, Core 2 Duo E6850, Core 2 Quad Q6600, Core 2 Quad Q6700, Core 2 Extreme QX6700, Core 2 Extreme QX6800, and Core 2 Extreme QX6850.

The process 500 continues by requesting a whole category (block 528) using the ICS API 524. For example, all products in the category “graphics card” may be requested from the ICS API 524.

The process 500 continues by requesting specifications for products (block 532) using the CNET API 536. For example, the CNET API 536 may provide information about the price, manufacturer, graphics processor, graphics performance, video input, output port(s), compatibility, interface type, resolution, video RAM, etc.

The process 500 continues by presenting the user with a set of products for the given category that satisfy any compatibility rules based on the specification information and the user selecting one of the products in the given category (block 540). For example, if the user selects a performance desktop, the user may be presented with the list of processors described above. The user then selects one of the given processors. If the user has selected one of the given processors, then the user is only presented with graphics cards that will work with that given processor and are graphics cards that are affiliated with the performance desktop category.

The process 500 continues by determining if the category was the last category (block 544). If no, the process 500 returns to block 508 and repeats until the last category is reached. If yes, the process 500 continues by displaying a configuration list 548. For example, if the user selected a given “graphics card”, then the process would continue with the next category in the category sequence: “RAM”. The process would continue to repeat until a given “power supply” product was selected by the user. After the “power supply” is selected, the configuration list that represents all of the products to build the product is presented to the user.

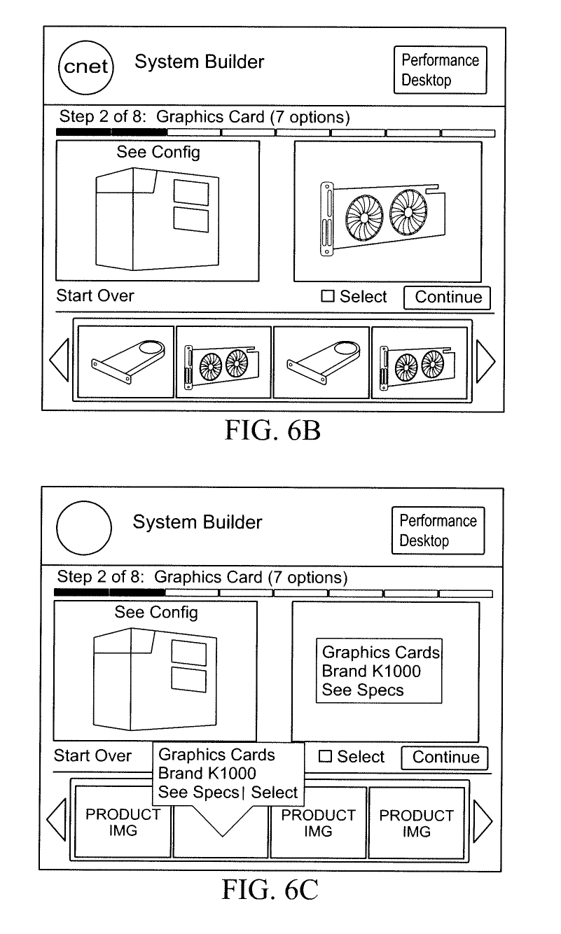

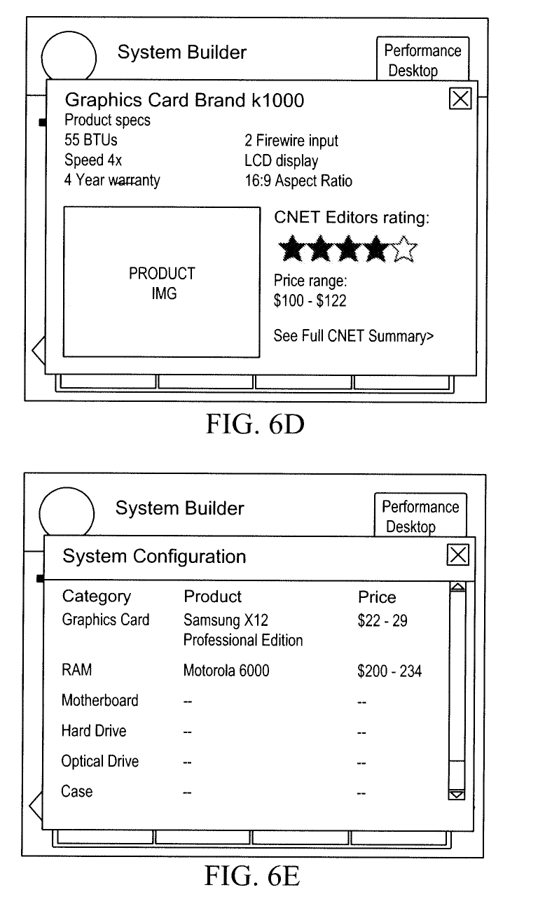

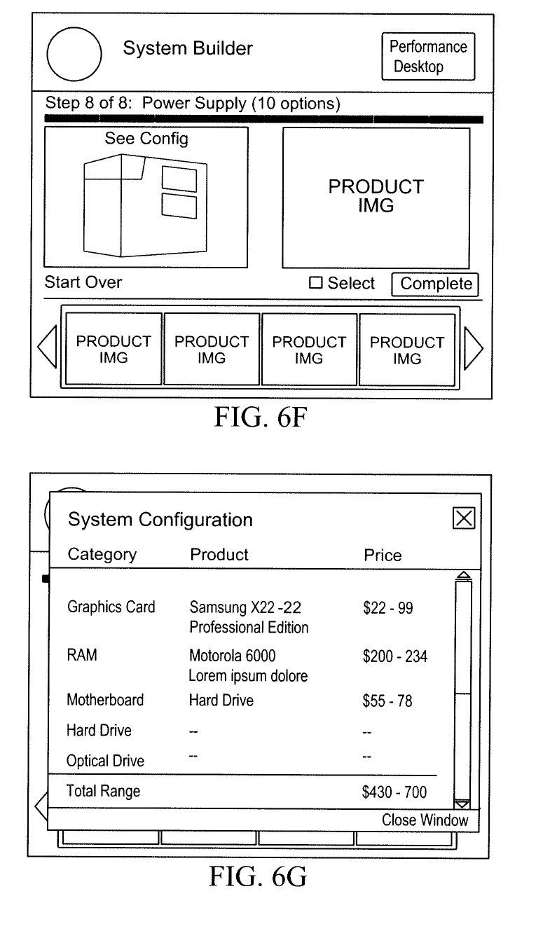

FIGS. 6A-6G illustrate exemplary user interfaces that can be used to help a user build a computer system. As shown in FIG. 6A, the initial frame presents the user with an overall system type they would like to build. For example, the user may select from a gaming system, a performance system, a small form factor system or a budget system. The system type automatically filters appropriate component categories throughout the component selection experience. Choosing a gaming system, for instance, will filter out non 3D capable graphics cards.

As shown in FIG. 6B, the component selection interface includes a list of components that are compatible with the selected system type. A frame similar to the frame shown in FIG. 6B is presented for each category of component (e.g., processor, motherboard, memory, graphics card, optical drive, hard drive, cases, and power supply.) The frame includes product names and images from the catalog of products.

The frame may also includes product specifications and configuration details when the users hover over particular areas with the mouse. For example, as shown in FIG. 6C, the user may be able to rollover an image in the scollbar which causes a popup window to be displayed to the user. If the user selects a link in the pop up window, a spec window may be displayed as shown in FIG. 6D. If the user selects a configuration link, the system configuration window is displayed as shown in FIG. 6E.

As shown in FIG. 6F, the user selects the final component to be added to complete the build process. When the build process is completed, a final frame is presented to the user that summarizes the user's component selections, pricing information, and/or hyperlinks to the online retailers' purchases pages as shown in FIG. 6G.

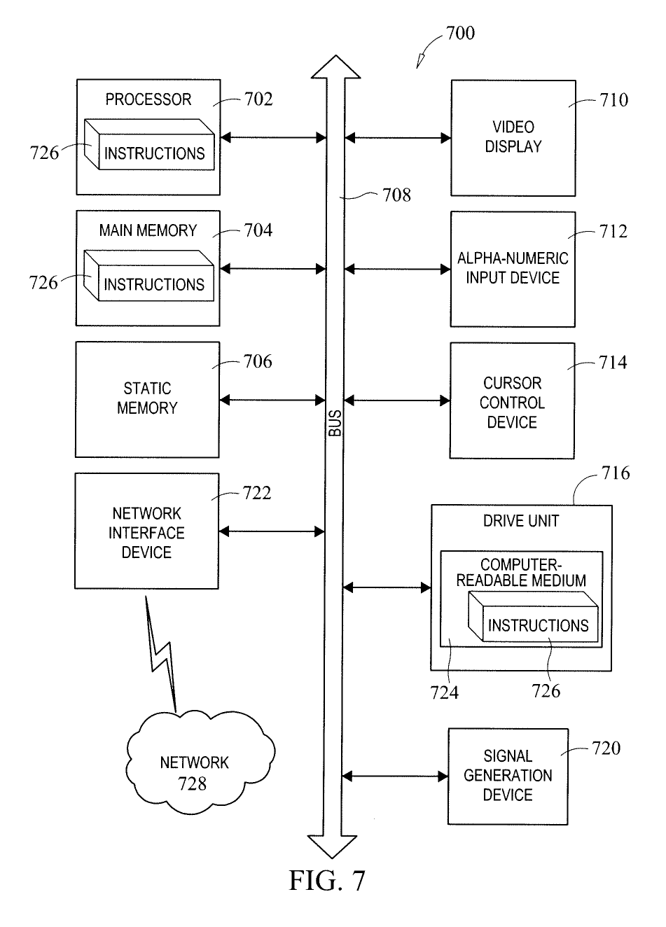

FIG. 7 shows a diagrammatic representation of machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU), a graphics processing unit (GPU) or both), a main memory 704 (e.g., read only memory (ROM), flash memory, dynamic random access memory (DRAM) such as synchronous DRAM (SDRAM) or Rambus DRAM (RDRAM), etc.) and a static memory 706 (e.g., flash memory, static random access memory (SRAM), etc.), which communicate with each other via a bus 708.

The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 720 (e.g., a speaker) and a network interface device 722.

The disk drive unit 716 includes a computer-readable medium 724 on which is stored one or more sets of instructions (e.g., software 726) embodying any one or more of the methodologies or functions described herein. The software 726 may also reside, completely or at least partially, within the main memory 704 and/or within the processor 702 during execution thereof by the computer system 700, the main memory 704 and the processor 702 also constituting computer-readable media.

The software 726 may further be transmitted or received over a network 728 via the network interface device 722.

While the computer-readable medium 724 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

It should be noted that the product builder is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. A computer system comprising:
a processor comprising:
a first application programming interface configured to access component specifications;
a second application programming interface configured to access a relationship engine that identifies relationships among a plurality of components; and
an application coupled to the first application programming interface and the second application programming interface, and configured to receive a user request to build a product having at least two of the plurality of components;
identify at least two categories of the product, a plurality of components associated with each of the at least two categories of the product, and the relationships among the plurality of components, display a first list of a plurality of components associated with a first one of the at least two categories of the product, receive a user selection of one of the plurality of components in the first list, display a second list of a plurality of components associated with a second one of the at least two categories that are compatible with the user selected component using the identified relationships and the component specifications, receive a user selection of one of the plurality of components in the second list, and display the user-selected components; memory coupled to the processor.

2. The computer system of claim 1, wherein the application is a widget embeddable on a web page.

3. The computer system of claim 1, wherein the application comprises a plurality of rules for identifying components based on the specifications and relationships, and an engine executes the rules in response to user input and displays the identified components to the user.

4. The computer system of claim 1, wherein the first application programming interface is further configured to access component pricing data and component images, and wherein the application is configured to display the component pricing data and component images.

5. The computer system of claim 1, wherein the application is configured to receive user input identifying a plurality of components to build the product.

6. The computer system of claim 5, wherein the application is configured to display the product with a link to purchase each of the plurality of components.

7. The computer system of claim 5, wherein the application is configured to display the product with a link to order a built product that includes the plurality of components.

8. The computer system of claim 1, wherein the product is a computer.

9. A computer-implemented method comprising:
receiving a user request to build a product having a plurality of components;
identifying by a processor at least two categories of the product, a plurality of components associated with each of the at least two categories of the product, and relationships between the plurality of components;
displaying a first list of a plurality of components associated with a first one of the at least two categories of the product;
receiving a user selection of one of the plurality of components in the first list;
displaying a second list of a plurality of components associated with a second one of the at least two categories that are compatible with the user selected component using the identified relationships;
receiving a user selection of one of the plurality of components in the second list; and
displaying the user-selected components.

10. The method of claim 9, wherein identifying the relationships between the plurality of components comprises identifying specifications for the plurality of components and analyzing the specifications of the plurality of components to determine compatibility.

11. The method of claim 9, wherein displaying the second list of the plurality of components comprises identifying a plurality of components associated with a category of the selected component.

12. The method of claim 9, further comprising identifying specifications for each of the plurality of components and wherein identifying the relationships between the plurality of components comprises analyzing the specifications of the plurality of components to determine compatibility.

13. The method of claim 9, further comprising accessing component pricing data and component images, and wherein displaying the first list and the second list further comprises displaying the pricing data and the images.

14. The method of claim 9, wherein the product is a computer.

15. The method of claim 9, further comprising:
determining the compatibility of the plurality of components in the first list with the category of the product before displaying the first list of plurality of components; and
determining the compatibility of the plurality of components in the second list with the user selected component from the first list.

16. A computer-readable storage media having computer executable instructions stored thereon which cause a computer system to carry out a method when executed, the method comprising:
receiving a user request to build a product having a plurality of components;
identifying at least two categories of the product, a plurality of components associated with each of the at least two categories of the product, and relationships between the plurality of components;
displaying a first list of a plurality of components associated with a first one of the at least two categories of the product;
receiving a user selection of one of the plurality of components in the first list;
displaying a second list of a plurality of components associated with a second one of the at least two categories that are compatible with the user selected component using the identified relationships;
receiving a user selection of one of the plurality of components in the second list; and
displaying the user selected components that build the product.

17. The computer-readable storage media of claim 16, wherein identifying the relationships between the plurality of components comprises identifying specifications for the plurality of components and analyzing the specifications of the plurality of components to determine compatibility.

18. The computer-readable storage media of claim 16, wherein displaying the second list of the plurality of components comprises identifying a plurality of components associated with a category of the selected component.

19. The computer-readable storage media of claim 16, further comprising identifying specifications for each of the plurality of components and wherein identifying the relationships between the plurality of components comprises analyzing the specifications of the plurality of components to determine compatibility.

20. The computer-readable storage media of claim 16, further comprising accessing component pricing data and component images, and wherein displaying the first list and the second list further comprises displaying the pricing data and the images.

21. The computer-readable storage media of claim 16, wherein the product is a computer.

22. The computer-readable storage media of claim 16, further comprising:
determining the compatibility of the plurality of components in the first list with the category of the product before displaying the first list of plurality of components; and
determining the compatibility of the plurality of components in the second list with the user selected component from the first list.
